(19) United States
(12) Patent Application Publication
(10) Pub. No.: US 2016/0272790 A1
(43) Pub. Date: Sep. 22, 2016

(54) FILLER-CONTAINING SILICONE COMPOSITIONS

(71) Applicant: WACKER CHEMIE AG, München (DE)

(72) Inventor: Philipp MUELLER, Burghausen (DE)

(21) Appl. No.: 14/442,353

(22) PCT Filed: Nov. 12, 2013
(86) PCT No.: PCT/EP2013/073633

§ 371 Date: May 12, 2015

(30) Foreign Application Priority Data
Nov. 13, 2012 (DE) 10 2012 220 700.7

(51) Int. Cl. C08K 9/02; C09D 5/08; C08G 77/38; C09D 183/04

(52) U.S. Cl. CPC C08K 9/02; C09D 183/04; C09D 5/08; C08G 77/38; C08G 2150/90; C08K 2201/003

(57) ABSTRACT

Corrosion of electrical and electronic components by sulfur and sulfur-containing compounds is achieved by coating, sealing, or encapsulating the component with an addition curable organopolysiloxane composition containing silicatic hollow microbeads with a metallic silver coating.

### CROSS REFERENCE TO RELATED APPLICATIONS

This application is the U.S. National Phase of PCT Appin. No. PCT/EP2013/073633 filed Nov. 12, 2013, which claims priority to German Application No. 10 2012 220 700.7 filed Nov. 13, 2012, the disclosures of which are incorporated in their entirety by reference herein.

### BACKGROUND OF THE INVENTION

1. Field of the Invention

The invention relates to filled addition-crosslinking silicone compositions which in particular permit protective encapsulation of electrical and electronic components exposed to a highly corrosive environment.

2. Description of the Related Art

Silicone casting compositions are widely used to protect electronic circuits from corrosion. Electronic components are nowadays also increasingly exposed to particularly aggressive, detrimental sulfur-containing gases. The silicone casting compositions available hitherto have high permeability to sulfur, hydrogen sulfide, sulfur dioxide, carbon disulfide, and other organylsulfur compounds, and resultant corrosion of the metallic conductor tracks leads to failures and shortened lifetimes of these components.

EP 1 295 905 A1 describes silicone encapsulating compositions which comprise metal powders as fillers, for example powders made of silver, copper, iron, nickel, aluminum, tin, and zinc, preference being given here to use of copper powder. However, the solution provided in that document, using purely metallic surfaces, is still not sufficiently effective, since only a relatively small effective surface area of the metal is available for the reaction that intercepts the sulfur gases. There are moreover numerous other disadvantages associated with this solution, for example high price, high density, and disadvantageous damping properties. A particularly disadvantageous factor is sedimentation of the metal-containing fillers in the silicone composition; this leads to inhomogeneous filler distribution.

### SUMMARY OF THE INVENTION

It was therefore an object to provide filled silicone compositions which do not have the abovementioned disadvantages, provide good protection of metallic surfaces, and in particular of electronic components, with respect to detrimental sulfur-containing gases, and exhibit no sedimentation of the fillers present in the silicone compositions, the aim being to ensure homogeneous filler distribution. These and other objects are achieved via the invention, which provides addition-crosslinking silicone compositions comprising

(1) organosilicon compounds which have moieties having aliphatic carbon-carbon multiple bonds,

(2) organosilicon compounds having Si-bonded hydrogen atoms,

(3) catalysts which promote an addition reaction between Si-bonded hydrogen and an aliphatic multiple bond, and

(4) as fillers, silicatic hollow glass microbeads with a silver coating, where more than 95% by weight of the silver applied to the silicatic hollow glass micr

### DETAILED DESCRIPTION OF THE PREFERRED EMBODIMENTS

The silicone compositions of the invention can be single-component silicone compositions or two-component silicone compositions.

If the silicone compositions of the invention are provided in the form of two-component silicone compositions, the two components can comprise all of the constituents in any desired combination, with the proviso that the constituents (2) and (3) are separated from one another.

Organosilicon compounds (1) which have moieties having aliphatic carbon-carbon multiple bonds are preferably linear or branched organopolysiloxanes made of units of the general formula

RₐR¹_{b}SiO_{(4-a-b)/2} (I),

where

R is a monovalent, optionally substituted, hydrocarbon moiety that is free from aliphatic carbon-carbon multiple bonds and has from 1 to 18 carbon atoms per moiety, and

R¹ is a monovalent hydrocarbon moiety which has a an aliphatic carbon-carbon multiple bond and has from 2 to 8 carbon atoms per moiety,

a is 0, 1, 2, or 3,

b is 0, 1, or 2,

and the sum a+b is 0, 1, 2, or 3,

with the proviso that the average number of moieties R¹ present is at least 2.

It is preferable that organosilicon compounds (1) comprise organopolysiloxanes of the general formula

R¹_{g}R_{3-g}SiO(SiR₂O)ₙ(SiRR¹O)ₘSiR_{3-g}R¹_{g} (II)

where R and R¹ are defined as stated above,

g is 0, 1, or 2,

n is 0 or an integer from 1 to 1500, and

m is 0 or an integer from 1 to 200,

with the proviso that the average number of moieties R¹ present is at least 2.

For the purposes of this invention, formula (II) is intended to mean that n units —(SiR₂O)— and m units —(SiRR¹O)— can have any desired distribution in the organopolysiloxane molecule.

Examples of moieties R are alkyl moieties, for example the methyl, ethyl, n-propyl, isopropyl, 1-n-butyl, 2-n-butyl, isobutyl, tert-butyl, n-pentyl, isopentyl, neopentyl, and tert-pentyl moieties, hexyl moieties, for example the n-hexyl moiety, heptyl moieties, for example the n-heptyl moiety, octyl moieties, for example the n-octyl moiety, and isooctyl moieties, for example the 2,2,4-trimethylpentyl moiety, nonyl moieties, for example the n-nonyl moiety, decyl moieties, for example the n-decyl moiety, dodecyl moieties, for example the n-dodecyl moiety, and octadecyl moieties, for example the n-octadecyl moiety; cycloalkyl moieties such as the cyclopentyl, cyclohexyl, cycloheptyl, and methylcyclohexyl moieties; aryl moieties, for example the phenyl, naphthyl, anthryl, and phenanthryl moieties; alkaryl moieties such as the o-, m-, and p-tolyl moieties, xylyl moieties, and ethylphenyl moieties; and aralkyl moieties, for example the benzyl moiety, and the α- and the β-phenylethyl moieties.

Examples of substituted moieties R are haloalkyl moieties, for example the 3,3,3-trifluoro-n-propyl moiety, the 2,2,2,2′,2′,2′-hexafluoroisopropyl moiety, the heptafluoroisopropyl moiety, and haloaryl moieties, for example the o-, m- and p-chlorophenyl moiety, and also all of the moieties mentioned above for R, where these preferably can have substitution by the following groups: mercapto, epoxy-functional groups, carboxy, keto, enamine, amino, aminoethylamino, isocyanato, aryloxy, acryloxy, methacryloxy, hydroxyl, and halo.

It is preferable that the moiety R is a monovalent hydrocarbon moiety having from 1 to 6 carbon atoms, and particular preference is given to here to the methyl moiety.

R¹ is a monovalent, SiC-bonded hydrocarbon moiety having an aliphatic carbon-carbon multiple bond.

Examples of moieties R¹ are alkenyl moieties, for example the vinyl, 5-hexenyl, cyclohexenyl, 1-propenyl, allyl, 3-butenyl, and 4-pentenyl moieties, and alkynyl moieties, for example the ethynyl, propargyl, and 1-propynyl moieties.

It is preferable that the moiety R¹ is an alkenyl moiety, and particular preference is given here to the vinyl moiety.

The average viscosity of the organosilicon compounds (1) of the invention is preferably from 200 to 100,000 mPa·s at 25° C., more preferably from 500 to 20,000 mPa·s at 25° C., and with particular preference from 500 to 5000 mPa·s at 25° C.

It is possible to use one type of organosilicon compound (1) or various types of organosilicon compounds (1).

It is preferable that organosilicon compounds (2) having Si-bonded hydrogen atoms comprise linear, cyclic, or branched organopolysiloxanes made of units of the general formula

R_{c}H_{d}SiO_{(4-c-d)/2} (II),

where

R is defined as stated above,

c is 0, 1, 2, or 3,

d is 0, 1, or 2,

and the sum e+f is 0, 1, 2, or 3,

with the proviso that the average number of Si-bonded hydrogen atoms present is at least 2.

It is preferable that organosilicon compounds (2) used comprise organopolysiloxanes of the general formula

HₕR₃₋ₕSiO(SiR₂O)ₒ(SiRHO)ₚSiR₃₋ₕHₕ (IV),

where R is defined as stated above,

h is 0, 1, or 2,

o is 0 or an integer from 1 to 1500, and

p is 0 or an integer from 1 to 200,

with the proviso that the average number of Si-bonded hydrogen atoms present is at least 2.

It is particularly preferable that the organosilicon compounds (2) comprise at least 3 Si-bonded hydrogen atoms.

For the purposes of this invention, formula (IV) is intended to mean that o units —(SiR₂O)— and p units —(SiRHO)— can have any desired distribution in the organopolysiloxane molecule.

Particular examples of these organopolysiloxanes (2) are copolymers made of dimethylhydrosiloxane, methylhydrosiloxane, dimethylsiloxane, and trimethylsiloxane units, copolymers made of trimethylsiloxane, dimethylhydrosiloxane, and methylhydrosiloxane units, copolymers made of trimethylsiloxane, dimethylsiloxane, and methylhydrosiloxane units, copolymers made of methylhydrosiloxane, and trimethylsiloxane units, copolymers made of methylhydrosiloxane, diphenylsiloxane, and trimethylsiloxane units, copolymers made of methylhydrosiloxane, dimethylhydrosiloxane, and diphenylsiloxane units, copolymers made of methylhydrosiloxane, phenylmethylsiloxane, trimethylsiloxane, and/or dimethylhydrosiloxane units, copolymers made of methylhydrosiloxane, dimethylsiloxane, diphenylsiloxane, trimethylsiloxane, and/or dimethylhydrosiloxane units, and also copolymers made of dimethylhydrosiloxane, trimethylsiloxane, phenylhydrosiloxane, dimethylsiloxane, and/or phenylmethylsiloxane units.

The average viscosity of the organosilicon compounds (2) of the invention is preferably from 10 to 1000 mPa·s at 25° C., more preferably from 30 to 300 mPa·s at 25° C.

It is possible to use one type of organosilicon compound (2) or various types of organosilicon compounds (2).

Quantities of the organosilicon compounds (2) are preferably from 0.1 to 5 mol, with preference from 0.2 to 2 mol of Si-bonded hydrogen per mole of Si-bonded moiety having an aliphatic carbon-carbon multiple bond in the organosilicon compound (1).

Catalysts (3) that promote an addition reaction between Si-bonded hydrogen and aliphatic multiple bonds in the silicone compositions of the invention can also be the same as those that could also be used hitherto to promote an addition reaction between Si-bonded hydrogen and an aliphatic multiple bond.

It is preferable that the catalysts are a metal from the group of the platinum metals or a compound or a complex from the group of the platinum metals. Examples of these catalysts are metallic and finely-divided platinum, which can be present on supports, for example silicon dioxide, aluminum oxide, or activated charcoal, compounds or complexes of platinum, for example platinum halides, e.g. PtCl₄, H₂O H2PtCl6.6H2O, Na₂PtCl₄.4H₂O, platinum-olefin complexes, platinum-alcohol complexes, platinum-alcoholate complexes, platinum-ether complexes, platinum-aldehyde complexes, platinum-ketone complexes, inclusive of reaction products from H₂PtC1₆.6H₂O and cyclohexanone, platinum-vinyl-siloxane complexes, for example 1,3-divinyl-1,1,3,3-tetramethyldisiloxaneplatinum complexes with or without detectable content of inorganically bonded halogen, bis(gamma-picoline)-platinum dichloride, trimethylenedipyridineplatinum dichloride, dicyclopentadieneplatinum dichloride, dimethylsulfoxideethyleneplatinum(II) dichloride, cyclooctadieneplatinum dichloride, norbornadieneplatinum dichloride, gamma-picolineplatinum dichloride, cyclopentadieneplatinum dichloride, and also reaction products of platinum tetrachloride with olefin and primary amine or secondary amine, or primary and secondary amine, for example the reaction product of platinum tetrachloride dissolved in 1-octene with sec-butylamine; other examples are ammonium complexes of platinum.

Quantities of the catalyst used in the process of the invention are preferably from 0.1 to 100 ppm by weight (parts by weight per million parts by weight), preferably from 3 to 30 ppm by weight, calculated in each case as elemental platinum, and based on the total weight of the organosilicon compounds (1) and (2).

The density of the silicatic hollow glass microbeads of the invention with a silver coating, used as fillers (4), is preferably from 0.5 to 2.0 g/cm³, more preferably from 0.5 to 1.8 g/cm³, the average particle diameter is preferably from 1 to 100 μm, more preferably from 10 to 50 μm, and the silver content is preferably from 10 to 50% by weight, more preferably from 15 to 40% by weight.

It is preferable that 100% by weight of the silver applied to the silicatic hollow glass microbeads take the form of metallic silver.

The fillers (4) of the invention are commercially available with the trademark CONDUCT-O-FIL® as silver-coated hollow glass spheres from Potters. Examples are the products SH230S33 (silver content 33% by weight, particle diameter 44 μm, and density 0.5 g/cm³), SH400S20 (silver content 20% by weight, particle diameter 13 μm, and density 1.6 g/cm³), and SH400S33 (silver content 33% by weight, particle diameter 14 μm, and density 1.7 g/cm³).

Quantities of the silicatic hollow glass microbeads (4) coated with silver are preferably from 1 to 35% by weight, more preferably from 5 to 25% by weight, based in each case on the total weight of the addition-crosslinking silicone compositions.

The total silver content of the silicone compositions of the invention is preferably smaller than 15% by weight, with preference, from 0.5 to 10% by weight.

In relation to the filler (4), the combination of the invention made of silicatic hollow glass microbeads and silver coating, providing the silver for the binding of the detrimental sulfur-containing gases, has proven to be particularly effective for protecting electronic components covered by cast material from corrosion by detrimental sulfur-containing gases. The addition-crosslinking silicone compositions of the invention moreover exhibit no sedimentation of the filler (4) of the invention in the silicone compositions, thus ensuring homogeneous filler distribution. This is an advantage over filled silicone compositions which comprise metallic-silver-coated metal particles or, respectively, glass particles, or which comprise pure silver fillers, which exhibit not only inadequate protection from corrosion but also severe sedimentation of the fillers and therefore inhomogeneous filler distributions. In contrast to this, the silicone compositions of the invention comprise a silver-coated filler which is based on silicatic hollow glass microbeads, and which by virtue of its low density provides a markedly larger effective surface area per unit of weight for absorbing detrimental gases and, because of the markedly reduced difference in density in relation to the silicone polymer, exhibits no sedimentation. The addition-crosslinking silicone compositions of the invention have the further advantage of good flowability.

The silicone compositions of the invention can comprise other substances (5). These other substances (5) can comprise, for example, adhesion promoters. Examples of adhesion promoters are silanes having hydrolysable groups and SiC-bonded vinyl, acryloxy, methacryloxy, epoxy, anhydride, acid, ester, or ether groups, and also partial and mixed hydrolysates of these, where preference is given to silanes having vinyl groups and silanes having epoxy groups which comprise ethoxy or acetoxy groups as hydrolysable moieties, and particular preference is given to vinyltriethoxysilane, vinyltriacetoxysilane, epoxypropyltrimethoxysilane, and the partial and mixed hydrolysates of these. When adhesion promoters are used, the silicone compositions of the invention preferably comprise quantities of from 0.1 to 5% by weight of adhesion promoter, more preferably from 0.5 to 2% by weight. Other substances (5) that can be used comprise additives having a thixotropic effect, for example fumed silica, obtainable for example with trademark Wacker HDK® from Wacker Chemie AG. When additives having thixotropic effect are used, the silicone compositions of the invention preferably comprise quantities of from 0.5 to 15% by weight of additives having a thixotropic effect.

Examples of other substances (5) are reinforcing and non-reinforcing fillers which differ from constituent (4), flame retardants, agents for influencing electrical properties, dispersing agents, solvents, pigments, dyes, plasticizers, organic polymers, and heat stabilizers. When other substances are used, the silicone compositions of the invention preferably comprise quantities of from 0.1 to 5% by weight of the other substances, with preference from 0.5 to 2% by weight.

The silicone compositions of the invention are produced by mixing the constituents (1), (2), (3), and (4), and optionally (5).

The average viscosity of the silicone compositions of the invention, determined at shear rate D=10 1/s and 25° C., is preferably from 100 to 10,000 mPa·s, more preferably from 200 to 5000 mPa·s, and most preferably from 500 to 2000 mPa·s.

The silicone compositions of the invention can be crosslinked to give non-electrically conductive silicone rubbers or silicone gels, the volume resistivity of which is preferably at least 1×10¹⁰ ≠·cm.

The compositions of the invention can be crosslinked at room temperature, about 20° C., or at higher temperatures. It is preferable that the crosslinking takes place at from 70° C. to 180° C., more preferably at from 100 to 150° C. Energy sources preferably used for crosslinking by heating are ovens, e.g. convection drying ovens, heating tunnels, heated rolls, heated plates, or sources radiating heat in the infrared region.

The silicone compositions of the invention may be used as casting material for covering electrical or electronic components.

The invention further provides a method for avoiding or retarding the corrosion of electrical or electronic components by sulfur-containing gases, where the electrical or electronic components are covered or sealed or encapsulated by using a casting material made of the silicone composition of the invention, which cures to give a silicone rubber or silicone gel.

The invention therefore further provides electrical or electronic components covered or sealed or encapsulated by using a casting material, these being characterized in that the casting material is the silicone composition of the invention, which cures to give a silicone rubber or silicone gel.

In the examples described below, all data relating to parts and percentages is based on weight unless otherwise stated. All viscosity data moreover are based on a temperature of 25° C. Unless otherwise stated, the examples below are carried out at the pressure of the ambient atmosphere, i.e. about 1020 hPa, and at room temperature, i.e. at about 20° C., or at the temperature that arises when the reactance are combined at room temperature without additional heating or cooling.

### Inventive Examples 1-3 and Comparative Examples 1-3

### Description of Raw Materials

### Vinyl Polymers 1 and 2

vinyldimethylsiloxy-terminated dimethylpolysiloxanes with various viscosities (vinyl polymer 1:500 mPas·s at 25° C., vinyl polymer 2:20,000 mPas·s at 25° C.) produced by conventional processes.

### SiH Crosslinking Agent

a trimethylsilyl-terminated copolymer made of dimethylsiloxane units and methylhydrosiloxane units with viscosity 180 mPa·s at 25° C., and with 0.17% by weight content of Si-bonded hydrogen.

### Catalyst

1% by weight (based on elemental platinum) solution of a 1,3-divinyl-1,1,3,3-tetramethyldisiloxaneplatinum complex in an α,ω-divinyldimethylpolysiloxane with viscosity 1000 mPa·s at 25° C. (Karstedt catalyst).

### Filler 1 (of the Invention)

Spherical, silicatic hollow glass microbeads coated with metallic silver, average particle diameter about 14 μm, particle size distribution from 10-30 μm, silver content 33% by weight, density about 1.7 g/cm³, available from Potters as CONDUCT-O-FIL® SH400S33 silver-coated hollow glass spheres.

### Filler 2 (Not of the Invention)

Spherical silicate glass particles coated with metallic silver, average particle diameter about 34 μm, particle size distribution from 15 to 50 μm, silver content 8% by weight, density 2.6 g/cm³.

### Filler 3 (Not of the Invention)

Spherical copper metal particles coated with metallic silver, average particle diameter about 22 μm, particle size distribution from 10 to 30 μm, silver content 17% by weight, density about 5.0 g/cm³

The compositions, containing the vinyl polymers 1, and respectively, 2; the SiH crosslinking agent; the catalyst; and respectively the fillers 1, 2, and 3, were in each case homogenized in suitable mixers. After the mixing process, the silicone compositions were degassed for 5 min at 10 mbar. Filler content (fillers 1 to 3) was always 15% by weight, based in each case on the entire silicone composition.

The viscosity of the compositions was determined at 25° C. with a shear rate D=10 1/s.

### Flowability Test

Flowability was assessed visually on millimeter paper. The test is passed if within 60 seconds 10 g of the silicone composition flow out to give a circular area with a diameter at least 100 mm. This corresponds to a conventional requirement placed upon casting compositions for use in large-volume mass-production processes with satisfactory processing times.

### Sedimentation Test

Sedimentation was assessed visually. The test is passed if, 30 minutes after homogenization, no silicone oil deposit is discernible on the surface of an uncrosslinked silicone composition of thickness 100 mm. This corresponds to a conventional hardening time.

### Corrosion Test

The test substrates were composed of aluminum oxide ceramic of thickness 1 mm with a meandering pattern of printed silver conductor tracks. The width of the conductor tracks was 0.5 mm. The flowable mixtures of inventive examples 1 and 2 and, respectively, comparative examples 1 to 3 are applied in a layer thickness of 2 mm to the test substrates, degassed, and hardened at 150° C. for 60 minutes. Soft silicone gels are obtained.

The test substrates were placed together with 1 g of elemental sulfur powder in a 1 L desiccator. The desiccator was sealed and heated to 80° C. for a total of 14 days.

At defined intervals, the test substrates were removed, the silicone gel was removed, and the silver conductor track was checked visually for corrosion.

The test sample was assessed as acceptable (acc) if the silver track had not become discolored and exhibited metallic luster. The test sample was assessed as unacceptable (unacc) if the silver track had dark or black discoloration, indicating corrosion.

Table 1 collates the compositions of inventive examples 1 to 3 and, respectively, comparative examples 1 to 3, and also the results of the flowability test, the sedimentation test, and the corrosion test.

### Inventive Examples 1 and 2

Silicone compositions with fillers made of hollow glass microbeads and metallic silver coating with low density

### Inventive Example 3

Silicone composition with filler made of hollow glass microbeads and metallic silver coating with low density and high-viscosity silicone polymer

### Comparative Example 1 (Not of the Invention)

Silicone composition with filler made of spherical silicate glass particles and metallic silver coating with high density

### Comparative Example 2 (Not of the Invention)

Silicone composition with spherical copper particles and metallic silver coating with high density, by analogy with EP 1295905 A1

### Comparative Example 3 (Not of the Invention)

Silicone composition with spherical copper particles and metallic silver coating with high density, and with the same silver content as in inventive examples 1 and 2, by analogy with EP 1295905 A1

Inventive examples 1-3 show that freedom from sedimentation is achieved only by using the silicone compositions of the invention with the hollow glass beads and the silver coating with correspondingly low density of the filler, and that only with the silicone compositions of the invention is the corrosion problem adequately solved and longlasting and durable protection achieved for the substrates requiring protection from corrosion due to detrimental sulfur-containing gases. At the same time, inventive examples 1 and 2 also exhibit adequate flowability.

TABLE 1

| | | Inv. ex./Comp. | | | | | |
|---|---|---|---|---|---|---|---|
| | | IE1 | IE2 | IE3 | CE1 | CE2 | CE3 |
| Composition | Vinyl polymer 1: | 100 | 100 | — | 100 | 100 | 100 |
| | 500 mPas (25° C.) [g] | | | | | | |
| | Vinyl polymer 2: | — | — | 100 | — | — | — |
| | 20000 mPas (25° C.) [g] | | | | | | |
| | SiH crosslinking agent | 0.5 | 5.0 | 0.5 | 0.5 | 0.5 | 0.5 |
| | [g] | | | | | | |
| | Catalyst [g] | 0.2 | 0.2 | 0.2 | 0.2 | 0.2 | 0.2 |
| | Filler 1 [g] | 17.8 | 18.6 | 17.8 | — | — | — |
| | Filler 2 [g] | — | — | — | 17.8 | — | — |
| | Filler 3 [g] | — | — | — | — | 17.8 | 42.0 |
| Density of | [g/cm³] | 1.09 | 1.09 | 1.09 | 1.24 | 1.6 | 2.2 |
| composition | | | | | | | |
| Viscosity of | [mPas, 25° C., D = 10 1/s] | 900 | 850 | 22 000 | 850 | 800 | 950 |
| composition | | | | | | | |
| Flowability | Flow time for 10 g to | 50 | 45 | >600 | 45 | 40 | 60 |
| | reach 100 mm [sec] | | | | | | |
| | Assessment of | acc | acc | unacc | acc | acc | acc |
| | flowability | | | | | | |
| Density difference | Density of filler/ | 1.7 | 1.7 | 1.7 | 2.7 | 5.2 | 5.2 |
| | density of silicone | | | | | | |
| | matrix | | | | | | |
| Sedimentation | Assessment of | acc | acc | acc | unacc | unacc | unacc |
| after 60 min | sedimentation | | | | | | |
| Silver content | Silver in composition [% | 5 | 5 | 5 | 1.2 | 2.5 | 5.0 |
| | by wt.] | | | | | | |
| Corrosion test | after 24 h | acc | acc | acc | acc | acc | acc |
| | after 72 h | acc | acc | acc | acc | unacc | acc |
| | after 168 h | acc | acc | acc | unacc | unacc | unacc |
| | after 336 h | acc | acc | acc | unacc | unacc | unacc |

1-11. (canceled)

12. An addition-crosslinking silicone composition comprising:
(a) organosilicon compounds which have moieties bearing aliphatic carbon-carbon multiple bonds,
(b) organosilicon compounds bearing Si-bonded hydrogen atoms,
(c) catalysts which promote an addition reaction between Si-bonded hydrogen and an aliphatic multiple bond, and
(d) as one filler, silicatic hollow glass microbeads with a silver coating, where more than 95% by weight of the silver applied to the silicatic hollow glass microbeads is in the form of metallic silver.

13. The composition of claim 12, wherein the composition is crosslinkable to give non-electrically-conductive silicone rubbers or silicone gels.

14. The composition of claim 13, having a volume resistivity of at least 1×10¹⁰ Ω·cm.

15. The composition of claim 12, wherein the density of the silicatic hollow glass microbeads with a silver coating is from 0.5 to 2.0 g/cm³,
the average particle diameter is from 1 to 100 μm, and
the silver content is from 10 to 50% by weight.

16. The composition of claim 15, wherein the density of the silicatic hollow glass microbeads with a silver coating is from 0.5 to 1.8 g/cm³,
the average particle diameter is from 10 to 50 μm, and
the silver content is from 15 to 40% by weight.

17. The composition of claim 12, wherein the viscosity of the organosilicon compound(s) (a) is from 200 to 100,000 mPa·s at 25° C.

18. The composition of claim 12, wherein the viscosity of the organosilicon compound(s) (a) is from 500 to 20,000 mPa·s at 25° C.

19. The composition of claim 12, wherein the viscosity of the organosilicon compound(s) (a) is from 500 to 5,000 mPa·s at 25° C.

20. The composition of claim 12, wherein the organosilicon compound(s) (a) comprise linear or branched organopolysiloxanes comprising units of the formula
RₐR¹_{b}SiO_{(4-a-b)/2} (I),
where
R is a monovalent, optionally substituted, hydrocarbon moiety free from aliphatic carbon-carbon multiple bonds and having from 1 to 18 carbon atoms, and
R¹ is a monovalent hydrocarbon moiety having an aliphatic carbon-carbon multiple bond and from 2 to 8 carbon atoms per moiety,
a is 0, 1, 2, or 3,
b is 0, 1, or 2,
and the sum a+b is 0, 1, 2, or 3,
with the proviso that the average number of moieties R¹ present is at least 2.

21. The composition of claim 12, wherein organosilicon compounds (a) comprise organopolysiloxanes of the formula
R¹_{g}R_{3-g}SiO(SiR₂O)ₙ(SiRR¹O)ₘSiR_{3-g}R¹_{g} (II)
where
R is a monovalent, optionally substituted, hydrocarbon moiety free from aliphatic carbon-carbon multiple bonds and having from 1 to 18 carbon atoms, and
R¹ is a monovalent hydrocarbon moiety having an aliphatic carbon-carbon multiple bond and from 2 to 8 carbon atoms per moiety,
g is 0, 1, or 2,
n is 0 or an integer from 1 to 1500, and
m is 0 or an integer from 1 to 200,
with the proviso that the average number of moieties R¹ present is at least 2.

22. The composition of claim 12, wherein organosilicon compounds (b) comprise linear, cyclic, or branched organopolysiloxanes comprising units of the formula
R_{c}H_{d}SiO_{(4-c-d)/2} (II),
where
R is a monovalent, optionally substituted, hydrocarbon moiety free from aliphatic carbon-carbon multiple bonds and having from 1 to 18 carbon atoms, and
c is 0, 1, 2, or 3,
d is 0, 1, or 2,
and the sum e+f is 0, 1, 2, or 3,
with the proviso that the average number of Si-bonded hydrogen atoms present is at least 2.

23. The composition of claim 12, wherein organosilicon compounds (b) comprise organopolysiloxanes of the formula
HₕR₃₋ₕSiO(SiR₂O)ₒ(SiRHO)ₚSiR₃₋ₕHₕ (IV)
where
R is a monovalent, optionally substituted, hydrocarbon moiety free from aliphatic carbon-carbon multiple bonds and having from 1 to 18 carbon atoms, and
h is 0, 1, or 2,
o is 0 or an integer from 1 to 1500, and
p is 0 or an integer from 1 to 200,
with the proviso that the average number of Si-bonded hydrogen atoms present is at least 2.

24. A process for producing an addition-crosslinking silicone composition of claim 12, comprising mixing components (a), (b), (c), and (d) with one another.

25. A method for avoiding or retarding the corrosion of electrical or electronic component(s) by sulfur-containing gases, comprising coating, sealing, or encapsulating the electrical or electronic component(s) with a composition of claim 12, and curing to give a silicone rubber or silicone gel.

26. An electrical or electronic component coated, sealed, or encapsulated by a composition of claim 12, which has been cured to give a silicone rubber or silicone gel.
